(19) United States
(12) Patent Application Publication
(10) Pub. No.: US 2008/0281988 A1
(43) Pub. Date: Nov. 13, 2008

(54) Apparatus and method for initating a debug halt for a selected architectural state

(76) Inventors: Jason P. Peck, Sugar Land, TX (US); Gary L. Swoboda, Sugar Land, TX (US)

Correspondence Address: TEXAS INSTRUMENTS INCORPORATED, P O BOX 655474, M/S 3999, DALLAS, TX, 75265, US

(21) Appl. No.: 11/982,833

(22) Filed: Nov. 2, 2007

Related U.S. Application Data
(60) Provisional application No. 60/927,952, filed on May 7, 2007.

(51) Int. Cl. G06F 3/00; G06F 9/312

(52) U.S. Cl. 710/1; 712/227; 712/E09.033

(57) ABSTRACT

In a test and debug system wherein a target processing unit in a target processor receives test and debug commands from an external unit, an interface unit included in the target processor monitors the state of the target processing unit. The interface unit receives and stores a test and debug command identifying the test and debug procedure to be performed. Thereafter, the interface unit receives a control signal group indicating the target processing unit state during which the command is to be executed. When the target processor state, indicated by the control signal group, is identified by the interface unit, the stored command is applied to the target processing unit. In this manner, a test and debug procedure can be executed when the target processing unit is in a suitable state.

This Application claims the benefit of Provisional Application No. 60/927,952, filed May 7, 2007.

### BACKGROUND OF THE INVENTION

1. Field of the Invention

The present invention relates generally to the test and debug of a target processor and, more particularly, to a controllable initiation of the test and debug procedure.

2. Description of the Related Art

Referring to FIG. 1, a basic block diagram of a system 1 for the test and debug of a target processing unit 151 is shown. A host processor 10 includes a host processing unit 101 and an interface unit 105. The host processing unit 101 generates the commands which control the testing of target processing unit 151 and analyzes the results of executing the commands in the target processor 15. The host processing unit 101 exchanges signals with the host interface unit 105.

The host interface unit 105 reformats signal groups and applies the reformatted signal groups to the target interface unit 155. The target interface unit 155 reformats the signal groups into a format suitable for use in the test and debug procedure. In addition, the target interface unit 155, using defined portions of the signal groups, sorts the signal groups categories and forwards the signal groups to the appropriate portion of the target processing unit 151.

After the test and debug procedure is completed, the results of the procedure are transferred from the target processing unit 151 to the target interface unit 155. In the target interface unit 155, the results of the test and debug procedure are formatted and transferred with a predetermined protocol. The results of the test and debug procedure are transferred from the target interface unit 155 to the host interface unit 105, the transferred signal groups are unformatted in a format acceptable to the host processing unit 101 and transferred thereto. The host processing unit 101 analyzes the data resulting from the test and debug procedure.

The apparatus described in FIG. 1 has been widely applied and has been successful in a variety of test and debug procedures, e.g., JTAG procedures. A problem has arisen in the prior art, when a command/procedure was forwarded to the target processor 15, the target processing unit was interrupted immediately to execute the test and debug procedure. This immediate execution could result in the interruption of the target processing activity at an inconvenient point.

A need has therefore felt for apparatus and an associated method having the feature that the interruption of a target processing unit would occur at designated state of the target processing unit. It is yet another feature of the apparatus and associated method to provide a plurality of selectable target processing unit states at which to begin a test and debug procedure. It is a more particular feature of the apparatus and associated method to generate a test and debug command and wait to execute the command until the target processing unit enters a preselected state.

### SUMMARY OF THE INVENTION

The aforementioned and other features of the apparatus and associated method are accomplished, according to the present invention, by the providing of a storage unit for storing, in the interface unit, a command for executing a test and debug procedure. The host processing unit also provides a signal group indicative of the selected state of the host processing unit when the command is to be executed. When the selected state of the host processing unit is identified, the command stored in the storage unit is retrieved from the storage unit, the contents of the storage unit cleared, and the test and debug procedure executed in response to the command.

The event/command may also be initiated from the target processing unit itself. An example of this would be where the CPU encounters an instruction that generates an event relevant to debug.

Other features and advantages of the present invention will be more clearly understood upon reading of the following description along with the accompanying figures and claims.

### BRIEF DESCRIPTION OF DRAWINGS

FIG. 1 is a block diagram illustrating the technique for initiating execution of a test and debug command prior art.

FIG. 2 is a block diagram illustrating the technique for initiating execution of a test and debug procedure according to the present invention.

### DESCRIPTION OF THE PREFERRED EMBODIMENTS

1. Detailed Description of the Drawings

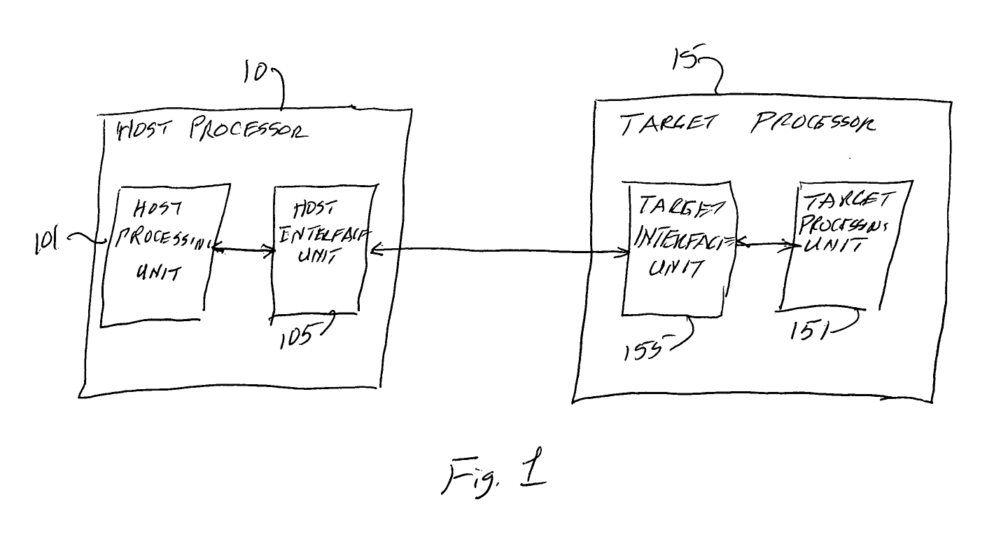

FIG. 1 has been described with respect to the related art.

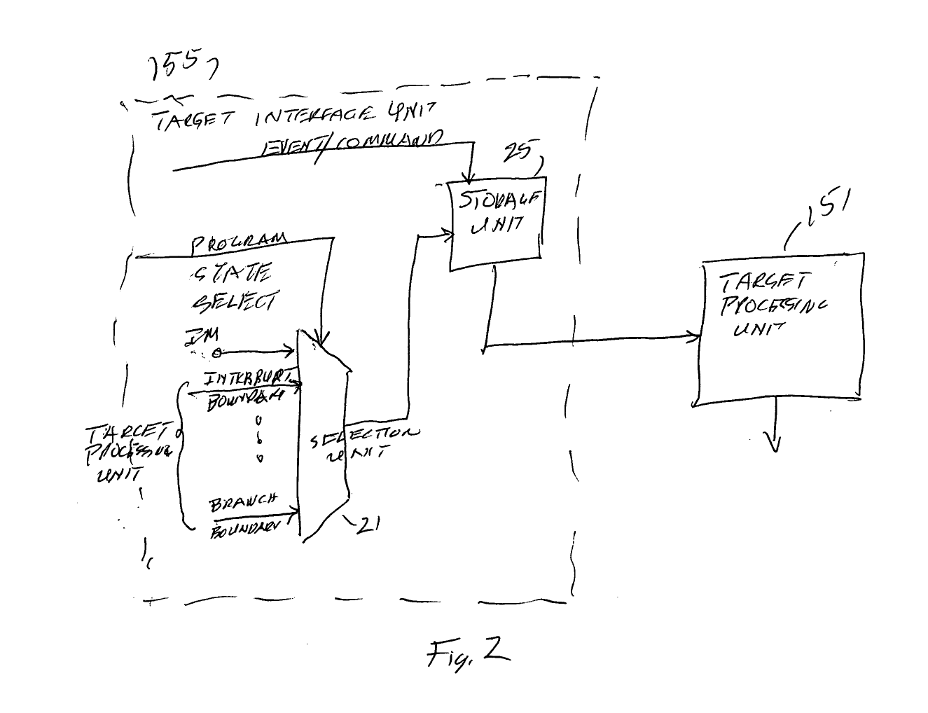

Referring now to FIG. 2, a block diagram illustrating the technique for initiating execution of test and debug command according to the present invention is shown. The additional apparatus required for the present invention is located in the target interface unit 155. An event/command is transmitted from the host interface unit 105 to the target interface unit 155 and stored in storage unit 25. In the prior art, the event/command would be applied to the target processing unit 151 and the test and debug procedure begins immediately, rather than be stored in storage unit 25. The host processing unit 101, in response to user input, generates a control signal that is transferred through the host interface unit 105 to the control terminal of selection unit 21. In response to the control signal, one of the input terminals is coupled to the output terminal. The input terminals of the selector unit 21 receive predetermined signals indicative of the state of the target processing unit 151. For example, a specified branch boundary may result in a signal being applied to an associated input terminal of selection unit 21. When the control signal has coupled the input terminal to the output terminals of the selector unit and a signal has been applied to the input terminal, a signal is applied to storage unit 25. The output signal from the selector unit applied to the storage unit 25 results in the event/command signal stored in the storage unit 25 to be applied to the target processing unit 151 and the storage unit 25 to be cleared in preparation for the next event command signal. The application of the signal stored in the storage unit 25 to target processing unit 151 results in the test and debug procedure.

2. Operation of the Preferred Embodiment

The operation of the present invention can be understood as follows. The present invention does not limit the test and debug procedure to being executed immediately, but permits the test and debug procedure to be executed in a predetermined state of the target processing unit. Or, when the proper input terminal of the selection unit is coupled to the output terminal by the appropriate control signal being applied to the control terminal of the selector unit, the event/execution procedure can be immediately executed.

The command/event that is typically stored in the storage unit is the debug halt command. This command halts the operation of the target processing unit so the test and debug procedures can be initiated.

Examples of the target processing machine states that can be used in the present invention are the immediate state of the target processing unit, next cycle boundary, interrupt capable boundary, reset vector, branch boundary, etc. The particular target processing unit state is determined by the user and, in the case of the preferred embodiment, forwarded to the target processor by the host processing unit.

Although the present invention has been described with respect to the preferred embodiment and drawings of the invention, it will be apparent to those skilled in the art that various adaptations, modifications, and alterations may be accomplished without departing from the spirit and scope of the present invention. Accordingly, it is to be understood that the accompanying drawings as set forth hereinabove are not intended to limit the breadth of the present invention, which should be inferred only from the following claims and their appropriately construed legal equivalents.

What is claimed is:

1. A target interface unit in a test and debug system, the test and debug system including a host processor, a target processor, and a host interface unit coupled to the target interface unit, the target interface unit comprising:
a selection unit, each input terminal of the selection unit receiving signal indicative of the state of the target processing unit, the control signal determining which selection unit input terminal is coupled to a selection unit output terminal; and
a storage unit, the storage unit storing a command signal group from the host interface unit;
wherein when a signal indicative of the state of the target processing unit is applied to an input terminal coupled to the output terminal of the selection unit, the output signal causes the command signal to be applied to the target processing unit.

2. The target interface unit as recited in claim 1 wherein the output signal causes the storage unit to be cleared.

3. The target interface unit as recited in claim 1 wherein the state of the target processing unit is selected from the group of states consisting of immediate machine state, a branch boundary, an interrupt capable boundary, next cycle, boundary, and a reset vector.

4. The target interface unit as recited in claim 1 wherein the control signal and the state selection are generated in the host processing unit.

5. The target interface unit as recited in claim 1 wherein the command signal group is a debug halt.

6. A method for determining when a test and debug procedure is initiated for a target processing unit, the method comprising:
storing a command, the command implementing a test and debug procedure; and
when a preselected target processing unit state is identified, applying the command to the target processing unit.

7. The method as recited in claim 6 wherein storing further includes:
receiving the command from a host processing unit; and
storing the command in a storage unit.

8. The method as recited in claim 6 further comprising selecting the machine states from the group consisting of an immediate machine state, a branch boundary, an interrupt capable boundary, next cycle, boundary, and a reset vector.

9. The method as recited in claim 6 wherein the command is a debug halt command.

10. A test and debug system, the system comprising:
a host processing unit;
a host interface unit exchanging test and debug signal groups with the host processing unit;
a target processing unit; and
a target interface unit, the target interface unit exchanging test and debug signal groups with the target processing unit and with the host interface unit, the target interface unit including:
a selection unit, the selection unit having signals indicative of the target processing unit states applied to each input terminal, the selection unit responsive to control signal groups for selecting a signal applied to the an input terminal to be applied to an output terminal of the selection unit; and
a storage unit for storing a test and debug command, the output signal of the selection unit being applied to the storage unit, the output signal of the selection unit causing the test and debug command to be applied to the target processing unit.

11. The system as recited in claim 10 wherein the test and debug command is a debug halt command.

12. The system as recited in claim 10 wherein the output signal of the selection unit, when applied to the storage unit, clears the contents of the storage unit.
